(19) United States
(12) Patent Application Publication
(10) Pub. No.: US 2014/0129741 A1
(43) Pub. Date: May 8, 2014

(54) PCI-EXPRESS DEVICE SERVING MULTIPLE HOSTS

(71) Applicant: MELLANOX TECHNOLOGIES LTD., Yokneam (IL)

(72) Inventors: Ariel Shahar, Jerusalem (IL); Eyal Waldman, Tel Aviv (IL); Michael Kagan, Zichron Yaakov (IL); Noam Bloch, Bat Shlomo (IL)

(73) Assignee: MELLANOX TECHNOLOGIES LTD., Yokneam (IL)

(21) Appl. No.: 13/670,485

(22) Filed: Nov. 7, 2012

(51) Int. Cl. G06F 13/14

(52) U.S. Cl. 710/33

(57) ABSTRACT

A method includes establishing in a peripheral device at least first and second communication links with respective first and second hosts. The first communication link is presented to the first host as the only communication link with the peripheral device, and the second communication link is presented to the second host as the only communication link with the peripheral device. The first and second hosts are served simultaneously by the peripheral device over the respective first and second communication links.

### FIELD OF THE INVENTION

The present invention relates generally to computing and communication systems, and particularly to serving multiple hosts using a single PCI-express device.

### BACKGROUND OF THE INVENTION

Peripheral Component Interconnect Express (PCIe) is a computer expansion bus standard, which is used for connecting hosts to peripheral devices such as Network Interface Cards (NICs) and storage devices. PCIe is specified, for example, in the PCI Express Base 3.0 Specification, November, 2010, which is incorporated herein by reference.

### SUMMARY OF THE INVENTION

An embodiment of the present invention that is described herein provides a method including establishing in a peripheral device at least first and second communication links with respective first and second hosts. The first communication link is presented to the first host as the only communication link with the peripheral device, and the second communication link is presented to the second host as the only communication link with the peripheral device. The first and second hosts are served simultaneously by the peripheral device over the respective first and second communication links.

In some embodiments, the first and second links include Peripheral Component Interconnect Express (PCIe) links, and the hosts include respective PCIe root complexes. In an embodiment, serving the first and second hosts includes exchanging communication packets between the hosts and a communication network. In another embodiment, serving the first and second hosts includes storing data for the hosts in a storage device. In a disclosed embodiment, serving the first and second hosts includes distributing a resource of the peripheral device among the first and second hosts transparently to the hosts.

In some embodiments, establishing the communication links includes negotiating link parameters for the first and second communication links with the first and second hosts, respectively, independently of one another. Serving the hosts may include setting for the first and second communication links a single global link configuration that matches the link parameters negotiated with the first and second hosts.

In an embodiment, serving the first and second hosts includes alternating among operational states in each of the first and second communication links independently of one another. In another embodiment, establishing the communication links includes receiving from the first and second hosts respective different first and second identifiers for the peripheral device, and serving the hosts includes using the different first and second identifiers over the first and second communication links, respectively.

In yet another embodiment, establishing the communication links includes receiving from the first and second hosts respective different first and second configuration parameters for the peripheral device, and serving the hosts includes using the different first and second configuration parameters over the first and second communication links, respectively. In still another embodiment, serving the hosts includes operating respective independent first and second flow-control mechanisms over the first and second communication links.

In another example embodiment, serving the hosts includes operating respective independent first and second packet sequence numbering mechanisms over the first and second communication links. In another embodiment, serving the first and second hosts includes serving respective first and second PCIe slots of a same host using the first and second PCIe links of the peripheral device.

There is additionally provided, in accordance with an embodiment of the present invention, a peripheral device including at least first and second interfaces for connecting to respective first and second hosts, and a link management unit. The link management unit is configured to establish first and second communication links with the respective first and second hosts, to present the first communication link to the first host as the only communication link with the peripheral device, to present the second communication link to the second host as the only communication link with the peripheral device, and to serve the first and second hosts simultaneously over the respective first and second communication links.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computing system, in accordance with an embodiment of the present invention; and

FIG. 2 is a flow chart that schematically illustrates a method for serving multiple hosts using a single peripheral device, in accordance with an embodiment of the present invention.

### DETAILED DESCRIPTION OF EMBODIMENTS

### Overview

Embodiments of the present invention that are described herein provide methods and systems for operating a peripheral device by multiple hosts over interfaces such as Peripheral Component Interconnect Express (PCIe). Example peripheral devices may comprise Network Interface Cards (NICs) or storage devices.

The PCIe interface is by nature a point-to-point, host-to-device interface that does not lend itself to multi-host operation. Nevertheless, the disclosed techniques enable multiple hosts to share the same peripheral device and thus reduce unnecessary hardware duplication.

In some embodiments, the peripheral device sets-up multiple PCIe links with the respective hosts, but presents each link to the corresponding host as the only existing link to the device. Consequently, each host operates as if it is the only host connected to the peripheral device. On the peripheral device side, the device manages multiple PCIe sessions with the multiple hosts simultaneously. The multiple PCIe links can also be viewed as a wide PCIe link that is split into multiple thinner links connected to the respective hosts.

Typically, the peripheral device trains and operates the PCIe links separately. For example, the device may transition each link between operational states (e.g., activity/inactivity states and/or power states) independently of the other links. The links are typically assigned different sets of identifiers and configuration parameters by the various hosts, and the device also manages a separate set of credits for each link.

Typically, the device negotiates the link parameters separately in each link vis-à-vis the respective host. In some embodiments, however, the device may later use a common link parameter that is within the capabilities of all hosts.

In summary, the disclosed techniques enable multiple hosts to share a peripheral device using PCIe in a manner that is transparent to the hosts. Moreover, the multi-host operation is performed without PCIe switching and without a need for software that coordinates among the hosts, and is therefore relatively simple to implement.

### System Description

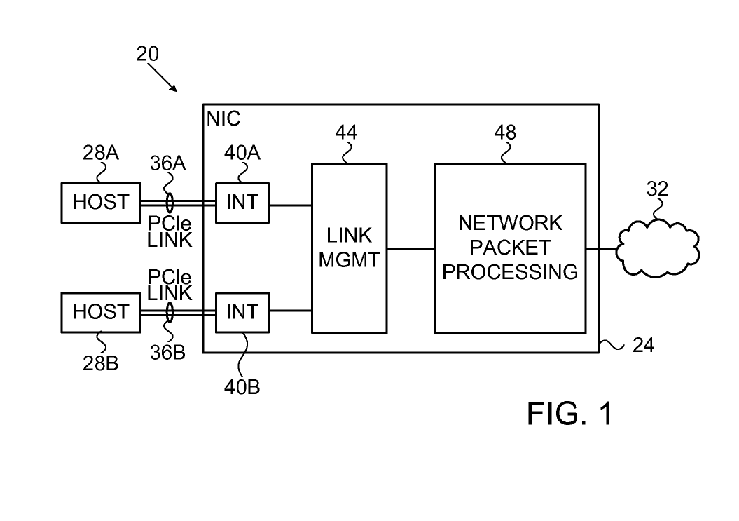

FIG. 1 is a block diagram that schematically illustrates a computing system 20, in accordance with an embodiment of the present invention. System 20 comprises a Network Interface Card (NIC) 24 that connects two hosts 28A and 28B simultaneously to a communication network 32. Each host may comprise, for example, a respective Central Processing Unit (CPU) of a computer or network element.

NIC 24 is presented herein as an example of a peripheral device that serves multiple hosts simultaneously, in the present example exchanges communication packets between the hosts and network 32. In alternative embodiments, the peripheral device (or simply “device” for brevity) may comprise a storage device that stores data for the multiple hosts, or any other suitable kind of peripheral device.

The present example refers to two hosts for the sake of clarity, although the disclosed techniques can be used for serving any desired number of hosts by a single peripheral device. For example, a sixteen-lane PCIe link (x16 PCIe) can be split into four four-lane links (x4PCIe) for four respective hosts, or into two x4 links and one x8 link for three respective hosts, or into any other suitable number of links having any suitable number of lanes. The links need not necessarily have the same number of lanes.

NIC 24 is connected to hosts 28A and 28B using PCIe links 36A and 36B, respectively. Each of links 36A and 36B typically complies with the PCIe base specification cited above. In the context of the present patent application and in the claims, the term “PCI Express” refers to the PCIe base specification cited above, as well as to previous and subsequent versions and other family members of this specification.

Each of links 36A and 36B may comprise one or more PCIe lanes, each lane comprising a bidirectional full-duplex serial communication link (e.g., a differential pair of wires for transmission and another differential pair of wires for reception). Links 36A and 36B may comprise the same or different number of lanes. A packet-based communication protocol, in accordance with the PCIe interface specification, is defined and implemented over each of the PCIe links.

NIC 24 comprises interface modules 40A and 40B, for communicating over PCIe links 36A and 36B with hosts 28A and 28B, respectively. A link management unit 44 manages the two PCIe links using methods that are described in detail below. In particular, unit 44 presents each PCIe link (36A and 36B) to the respective host (28A and 28B) as the only PCIe link existing with NIC 24. In other words, unit 44 causes each host to operate as if NIC 24 is assigned exclusively to that host, even though in reality the NIC serves multiple hosts.

NIC 24 further comprises a communication packet processing unit 48, which exchanges network communication packets between the hosts (via unit 44) and network 32. (The network communication packets, e.g., Ethernet frames or Infiniband packets, should be distinguished from the PCIe packets exchanged over the PCIe links.)

The system and NIC configurations shown in FIG. 1 are example configurations, which are chosen purely for the sake of conceptual clarity. In alternative embodiments, any other suitable system and/or NIC configuration can be used. Certain elements of processing NIC 24 may be implemented using hardware, such as using one or more Application-Specific Integrated Circuits (ASICs) or Field-Programmable Gate Arrays (FPGAs). Alternatively, some NIC elements may be implemented in software or using a combination of hardware and software elements.

In some embodiments, certain functions of NIC 24, such as certain functions of unit 44, may be implemented using a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Serving Multiple Hosts by a Single Peripheral Device Over Respective PCI-E Links

The PCIe protocol is by nature a point-to-point, host-to-device protocol, which does not support features such as point-to-multipoint operation or multi-host arbitration of any kind. Nevertheless, in some embodiments NIC 24 is configured to function as a single PCIe peripheral device that serves two or more PCIe hosts simultaneously. The multiple hosts are also referred to as root complexes.

Typically, link management unit 44 sets-up and operates PCIe links 36A and 36B, such that each host is presented with an exclusive non-switched PCIe link to device 24 that is not shared with other hosts. Each host is thus unaware of the existence of other hosts, i.e., the multi-host operation is transparent to the hosts. The resources of the peripheral device (processing resources, communication bandwidth in the present example of a NIC, or storage throughput in the case of a storage device) are allocated by unit 44 to the various hosts as appropriate. Unit 44 may perform such multi-host operation in various ways, and several example techniques are described below.

In an example embodiment, when setting up PCIe links 36A and 36B, unit 44 negotiates the link parameters (e.g., number of lanes, link speed or maximum payload size) independently with each host. The link parameters may generally comprise parameters such as various physical-layer (PHY), data-link layer and transaction-layer parameters. Since different hosts may have different capabilities, unit 44 attempts to optimize the parameters of each link without degrading one link because of limitations of a different host.

In some embodiments, however, after the link parameters are negotiated separately over each PCIe link, unit 44 may actually use a global link configuration that is supported by all the hosts. Consider, for example, a group of four hosts that configure the device for a maximum payload size of 128, 256, 512 and 1024 bytes, respectively. In this scenario, when actually generating payloads, unit 44 may generate 128-byte payloads for all four links, so as to match the capabilities of all hosts with a single global link configuration.

In some embodiments, unit 44 presents NIC 24 to the hosts separately, and thus receives separate and independent identifiers and configuration parameters from each host. For example, unit 44 may receive a separate and independent Bus-Device-Function (BDF) identifier from each host. Each host will typically enumerate NIC 24 separately, and set parameters such as PCIe Base Address Registers (BARs), other configuration header parameters, capabilities list parameters, MSIx table contents, separately and independently for each PCIe link. Unit 44 stores the separate identifiers and configuration parameters of the various links, and uses the appropriate identifier and configuration parameters on each link.

Typically, each of PCIe links 36A and 36B operates in accordance with a specified state machine or state model, which comprises multiple operational states and transition conditions between the states. The operational states may comprise, for example, various activity/inactivity states and/or various power-saving states.

In some embodiments, unit 44 operates this state model independently on each PCIe link, i.e., vis-à-vis each host. In other words, unit 44 carries out an independent communication session with each host. In these sessions, unit 44 may transition a given PCIe link from one operational state to another at any desired time, independently of transitions in the other links. Thus, the state transitions in one link are not affected by the conditions or state of another link.

In some embodiments, unit 44 operates separate and independent flow-control mechanisms vis-à-vis hosts 28A and 28B over links 36A and 36B. In an example embodiment, unit 44 manages a separate set of credits for each PCIe link (e.g., Posted/NotPosted or Header/Data) with regard to credit consumption and release.

As yet another example, unit 44 may operate separate and independent packet sequence numbering mechanisms vis-à-vis hosts 28A and 28B over links 36A and 36B. The PCIe specification, for example, defines a data reliability mechanism that uses Transaction Layer Packet (TLP) sequence numbering. Thus, unit 44 may use separate and independent TLP sequence numbers on each of the PCIe links.

The mechanisms described above are chosen purely for the sake of conceptual clarity. In alternative embodiments, unit 44 may present and operate NIC 24 separately on each PCIe link in any other suitable way.

In some embodiments, the disclosed techniques can be used for connecting NIC 24 to a single host using multiple PCIe links. This configuration can be viewed as setting hosts 28A and 28B to be the same host. Consider, for example, a host that supports only thin PCIe, e.g., x4 PCIe, but comprises multiple slots of this width. Such a host can be connected to an x16 PCIe peripheral device using the disclosed techniques. As a result, the host and device are able to exploit the full x16 PCIe bandwidth even though the host is limited to four PCIe lanes per slot.

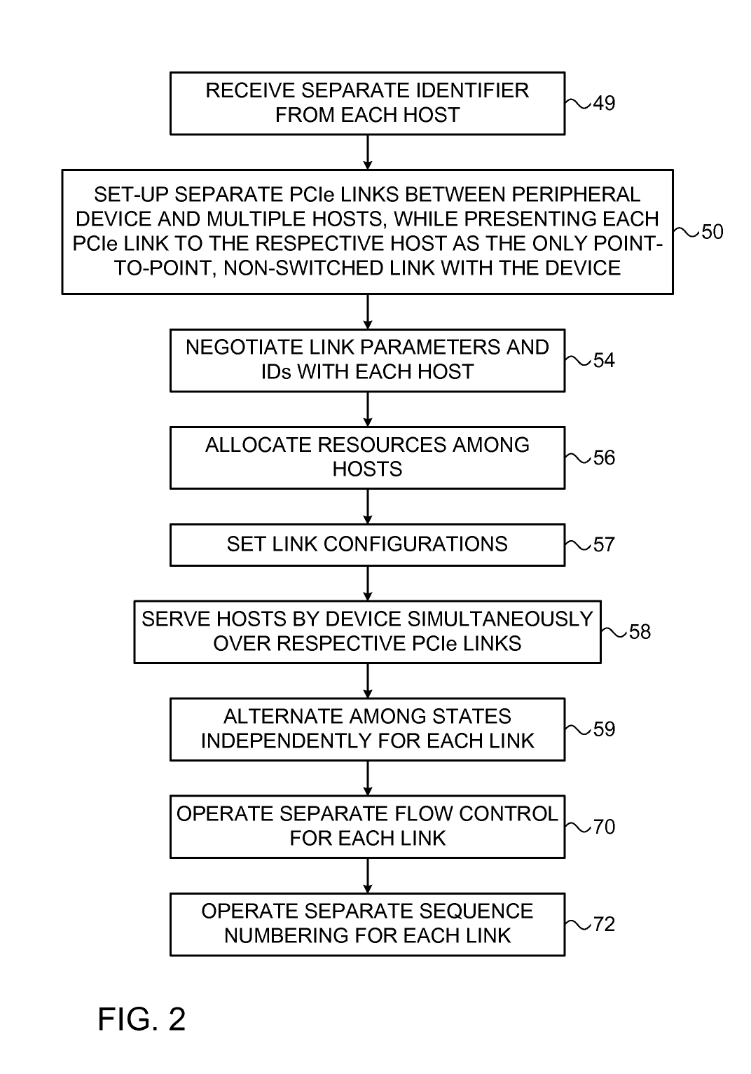

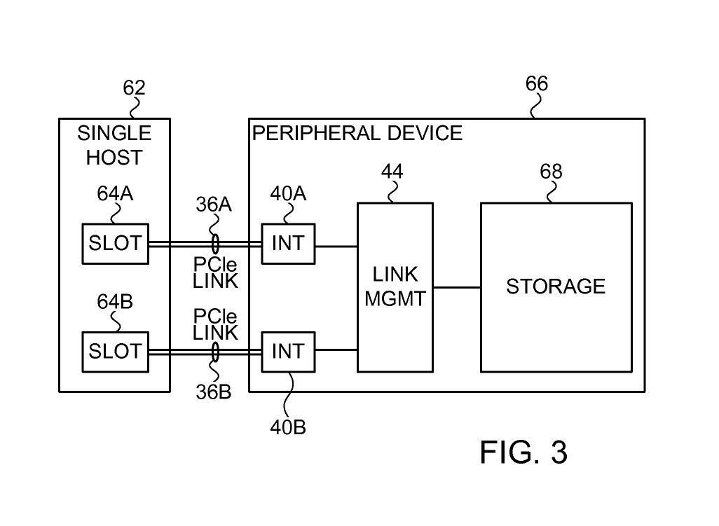

FIG. 2 is a flow chart that schematically illustrates a method for serving multiple hosts 28 using a single peripheral device 24, in accordance with an embodiment of the present invention. The method begins with unit 44 of device 24 establishing separate PCIe links with the respective hosts, at a link setup step 50. In setting up the links, unit 44 presents each PCIe link to the respective host as the only link existing to device 24.

Unit 44 negotiates link parameters independently with each host over the respective PCIe link, at a negotiation step 54. Unit 44 then serves the multiple hosts simultaneously over the respective PCIe links, at a serving step 58. Unit 44 distributes or otherwise shares the resources of device 24 among the hosts as needed.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
in a network interface card (NIC) peripheral device, establishing at least first and second PCIe_communication links with respective first and second hosts;
receiving by the NIC peripheral device from each of the first and second hosts, respective PCIe parameter settings to be used in communicating over the PCIe link with the host;
presenting the first PCIe communication link to the first host as the only communication link with the peripheral device, and presenting the second PCIe communication link to the second host as the only communication link with the peripheral device, the presenting includes using for each PCIe communication link the PCIe parameter settings received from the respective host; and
serving the first and second hosts simultaneously by the peripheral device over the respective first and second PCIe communication links.

2. The method according to claim 1, wherein the hosts comprise respective PCIe root complexes.

3. The method according to claim 1, wherein serving the first and second hosts comprises forwarding communication packets received from the hosts over a communication network.

4. The method according to claim 1, wherein serving the first and second hosts comprises storing data for the hosts in a storage device.

5. The method according to claim 1, wherein serving the first and second hosts comprises allocating a resource of the peripheral device among the first and second hosts transparently to the hosts.

6. The method according to claim 1, wherein establishing the communication links comprises negotiating link parameters for the first and second communication links with the first and second hosts, respectively, independently of one another.

7. The method according to claim 6, wherein serving the hosts comprises setting for the first and second communication links a single global link configuration that matches the link parameters negotiated with the first and second hosts.

8. The method according to claim 1, wherein serving the first and second hosts comprises alternating among operational states in each of the first and second communication links independently of one another.

9. The method according to claim 1, wherein establishing the communication links comprises receiving from the first and second hosts respective different first and second identifiers for the peripheral device, and wherein serving the hosts comprises using the different first and second identifiers over the first and second communication links, respectively.

10. (canceled)

11. The method according to claim 1, wherein serving the hosts comprises operating respective independent first and second flow-control mechanisms over the first and second communication links.

12. The method according to claim 1, wherein serving the hosts comprises operating respective independent first and second packet sequence numbering mechanisms over the first and second communication links.

13. The method according to claim 1, further comprising serving respective first and second PCIe slots of a same host using a plurality of PCIe links between the peripheral device and the same host.

14. A network interface card (NIC) peripheral device, comprising:
at least first and second PCIe interfaces for connecting to respective first and second hosts;
a network interface card (NIC) peripheral unit configured to provide peripheral services simultaneously to hosts connected to the PCIe interfaces; and
a link management unit, which is configured to establish first and second PCIe communication links with the respective first and second hosts, to receive from each of the first and second hosts, respective PCIe parameter settings to be used in communicating over the PCIe link with the host, to train and operate each PCIe link separately so as to present the first communication link to the first host as the only communication link with the peripheral device, and to present the second communication link to the second host as the only communication link with the peripheral device, the presenting includes using for each PCIe communication link the PCIe parameter settings received from the respective host.

15. (canceled)

16. The device according to claim 14, wherein the peripheral unit serves the first and second hosts by forwarding communication packets received from the hosts over a communication network.

17. The device according to claim 14, wherein the peripheral unit serves the first and second hosts by storing data for the hosts in a storage device.

18. The device according to claim 14, wherein the link management unit is configured to allocate a resource of the peripheral device among the first and second hosts transparently to the hosts.

19. The device according to claim 14, wherein the link management unit is configured to negotiate link parameters for the first and second communication links with the first and second hosts, respectively, independently of one another.

20. The device according to claim 19, wherein the link management unit is configured to set for the first and second communication links a single global link configuration that matches the link parameters negotiated with the first and second hosts.

21. The device according to claim 14, wherein the link management unit is configured to alternate among operational states in each of the first and second communication links independently of one another.

22. The device according to claim 14, wherein the link management unit is configured to receive from the first and second hosts respective different first and second identifiers for the peripheral device, and to use the different first and second identifiers over the first and second communication links, respectively.

23. (canceled)

24. The device according to claim 14, wherein the link management unit is configured to operate respective independent first and second flow-control mechanisms over the first and second communication links.

25. The device according to claim 14, wherein the link management unit is configured to operate respective independent first and second packet sequence numbering mechanisms over the first and second communication links.

26. The device according to claim 14, wherein the link management unit is additionally configured to serve respective first and second PCIe slots of a same host using PCIe links between the PCIe interfaces and the same host.

27. The method according to claim 1, wherein establishing the at least first and second PCIe communication links comprises establishing direct PCIe communication links which do not include PCIe switching.

28. The method according to claim 1, wherein receiving the PCIe parameter settings comprises receiving from each of the hosts a separate respective Bus-Device-Function (BDF) identifier.

29. The method according to claim 1, wherein receiving the PCIe parameter settings comprises receiving from each of the hosts separate respective PCIe Base Address Registers (BARs).

30. The method according to claim 1, wherein receiving the PCIe parameter settings comprises receiving from each of the hosts a separate respective MSIx table contents.
